(19) United States
(12) Patent Application Publication
(10) Pub. No.: US 2020/0189132 A1
(43) Pub. Date: Jun. 18, 2020

(54) GOLF DEVICES AND METHODS FOR USING SAME

(71) Applicant: GOLPHERS, INC., Arlington, TX (US)

(72) Inventors: Justin W. Barnhart, Arlington, TX (US); Eric Ochs, Arlington, TX (US)

(21) Appl. No.: 16/715,525

(22) Filed: Dec. 16, 2019

Related U.S. Application Data
(60) Provisional application No. 62/780,108, filed on Dec. 14, 2018.

(51) Int. Cl. B26B 11/00; A63B 57/50; A63B 57/30; A63B 57/20; A63B 57/35

(52) U.S. Cl. CPC B26B 11/00; A63B 57/50; A63B 57/35; A63B 57/207; A63B 57/353

(57) ABSTRACT

Disclosed herein are multi-tool devices for golfing. In one aspect, an multi-tool device includes a plurality of tool elements contained within a housing, the tool elements comprising at least one cutting element and one divot tool element, a plurality of locking mechanisms, each locking mechanism in operable communication with a tool element and configured to retain the tool element within the housing in a locked state, an attachment element connected on an outer surface of the housing and a ball marker releasable secured to the housing. Also disclosed herein are methods for using the disclosed devices.

### CROSS REFERENCE TO RELATED APPLICATIONS

This application claims the benefit of priority to U.S. Provisional Patent Application Ser. No. 62/780,108, filed on Dec. 14, 2018, the entire contents of which are hereby incorporated by reference herein.

It is intended that the above-referenced application may be applicable to the concepts and embodiments disclosed herein, even if such concepts and embodiments are disclosed in the referenced applications with different limitations and configurations and described using different examples and terminology.

### FIELD OF INVENTION

The present invention relates to golf devices and methods for using the disclosed golf devices.

### BACKGROUND OF THE INVENTION

Golf in the modern era requires more than just clubs and golf shoes to play. Accessory tools have grown in popularity and are now needed for proper play and maintenance of shared golf play areas. Tools such as a stencil to know which ball yours is, a divot tool for green repair, and a ball marker to indicate the location of golf balls, are all separate, but necessary requirements for golfing. All these tools being separate from one another can be annoying to store in your pockets while walking around and are easily misplaced.

Accordingly, there remains a need for a consolidated golf tool that keeps all the tools in one place, and the ability to secure, as to prevent movement in one's pocket while golfing. This need and other needs are met by the various aspects of the present disclosure.

### SUMMARY OF THE INVENTION

In accordance with the purposes of the invention, as embodied and broadly described herein, the invention, in one aspect, relates to golf devices, for example, a multi-tool device.

In one aspect, disclosed herein, is a multipurpose, multi-tool golf device. In further aspects, the device can comprise a plurality of tool elements contained within a housing. In still further aspects, the tool elements can comprise at least one cutting element and one divot tool element. In yet further aspects, device can comprise an attachment element or attachment assembly connected to an outer surface of the housing, the attachment element can comprise an assembly of a securing component, a hinge component, and a labeling guide component. In continuing aspects, the device can comprise a ball marker that can connect to the device housing.

In another aspect, a multiple purpose device can include a plurality of tool elements contained within a housing. The tool elements can include at least one cutting element and one divot tool element. The multiple purpose tool can also include a plurality of locking mechanisms. According to this aspect, each locking mechanism is in operable communication with a tool element and configured to retain the tool element within the housing in a locked state. The multiple purpose tool can also include an attachment element connected to the outer surface of the housing, and a golf ball marker releasably secured to a portion of the housing.

In some aspects, the golf ball marker is releasably secured via a magnetic force or a strategically placed magnet within the multiple purpose device. Additionally, in some aspects, the attachment element includes a pivoting stencil accessory configured to allow the marking of a straight line on a golf ball for aid in putting the golf ball.

In further aspects, the invention also relates to methods for using the disclosed devices and systems.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a side view of a golf device in a closed configuration, in accordance with an exemplary embodiment of the present invention.

FIG. 2 shows a side view of a golf device in a knife open configuration, in accordance with an exemplary embodiment of the present invention.

FIG. 3 shows a side view of a golf device in a fully open configuration, in accordance with an exemplary embodiment of the present invention.

FIG. 4 shows a perspective view of a golf device in a partially open configuration, in accordance with an exemplary embodiment of the present invention.

FIG. 5 shows a perspective view of a golf device in a fully open configuration, in accordance with an exemplary embodiment of the present invention.

FIG. 6 shows a perspective view of a golf device in a fully open configuration, in accordance with an exemplary embodiment of the present invention.

FIG. 7 shows a top view of a golf device in a knife open configuration, in accordance with an exemplary embodiment of the present invention.

FIG. 8 shows a side view of a golf device in a knife open configuration, in accordance with an exemplary embodiment of the present invention.

FIG. 9 shows a side view of a golf device in a closed configuration, in accordance with an exemplary embodiment of the present invention.

FIG. 10 shows a top view of an attachment assembly of a golf device, in accordance with an exemplary embodiment of the present invention.

FIG. 11 shows a perspective view of an attachment assembly of a golf device, in accordance with an exemplary embodiment of the present invention.

FIG. 12 shows a perspective view of an alternative golf device in a knife open configuration, in accordance with an exemplary embodiment of the present invention.

FIG. 13 shows a side view of an alternative golf device in a knife open configuration, in accordance with an exemplary embodiment of the present invention.

FIG. 14 shows a side view of an alternative golf device in a knife open configuration, in accordance with an exemplary embodiment of the present invention.

FIG. 15 shows a top view of an alternative golf device in a knife open configuration, in accordance with an exemplary embodiment of the present invention.

FIG. 16 shows a rear perspective view of an alternative golf device in a knife open configuration, in accordance with an exemplary embodiment of the present invention.

FIG. 17 shows an exploded assembly view of a golf device, in accordance with an exemplary embodiment of the present invention.

FIG. 18 is a flowchart of a method of using a golf device, including the golf devices illustrated in FIGS. 1-17, in accordance with an exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

The term “substantially” as used herein can be applied to modify any quantitative representation which could permissibly vary without resulting in a change in the basic function to which it is related. For example, the term “substantially planar” is intended to refer to a shape wherein a component or object is flat relative to perfectly flat surface, for example from about 80% to about 100% planar, e.g., 85%, 90%, 95%, 97%, 99%.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the invention as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Golf Devices

As briefly described above, the present disclosure relates, in various aspects, to multiple purpose, multi-tool devices and apparatuses, for example, for use in connection with golf-related functions. The multi-tool includes many unique features that set it apart from other multi-tools. It has a smooth, sleek design that is easy to use out on the golf course, and can also be substituted as an everyday carry pocket knife.

One unique feature is a one hand opening blade. This can be facilitated either by a flipper tab, with a thumb stud on one or both sides of the blade, or a thumb hole opener that allows a user to quickly open the blade into a locked, open configuration. According to one aspect, the knife blade is made of S35VN or a high-grade Stainless Blade Steel.

The multi-tool can also include a divot repair tool with a quick open thumb tab that allows the user to quickly open and make divot repairs on the putting surface. The divot tool is configured to repair indentations, impressions, or marks left from balls landing on the green. The divot tool is discretely hidden between the blade housing and the handle of the tool.

According to one aspect, the divot repair tool is made of titanium or Stainless Steel. The divot tool can also be used as a straight-line stencil for golfers to mark their ball using a permanent marker. This is important because the golfer uses the line on the ball to line up their putts. The divot tool can also be placed into the ground and then the handle bent over onto the ground to create a resting position so a golf club can rest on it. This is useful in the event that the grass is wet and you need to place your club down and don't want to get your grip wet.

According to another aspect, a metal, titanium, or stainless steel clip may be included that allows the user to easy store the tool in their pocket to eliminate movement during their swing, and it also prevents the tool from stabbing the user in the leg like traditional divot tools while bending down in a round of golf. The clip screw also runs through the knife and serves as a pivot for the divot tool.

According to another aspect, a Stainless-Steel magnetic coin ball marker can be included that allows the golfer to quickly remove the coin and mark their golf ball on the putting surface with ease.

The bolster of titanium or stainless steel incorporates magnets to allow the ball marker to virtually incorporate itself into the knife without being knocked free or falling loose. The magnets are strategically placed, and the correct strength tp prevent wearing out the flipper mechanism and causing the blade to malfunction. The Ball Marker is used to mark ball placement in places such as the green where the ball needs to be picked up to let others play. The Ball Marker can be easily lifted from the bolster by applying pressure near the finger coil which tilts the Marker out at an angle to the knife and allows the user to grab it.

A Stainless Steel bottle opener may be conveniently built in to the handle of the knife. Furthermore, according to other aspects, the body portion may be formed of a G10 fiberglass, fiberglass, and/or phenolic resin.

Titanium or stainless-steel liners and screws are anodized, and are the central structure for the tool, supporting the locking mechanism of the blade, and mount the handles to the tool while providing low maintenance functionality.

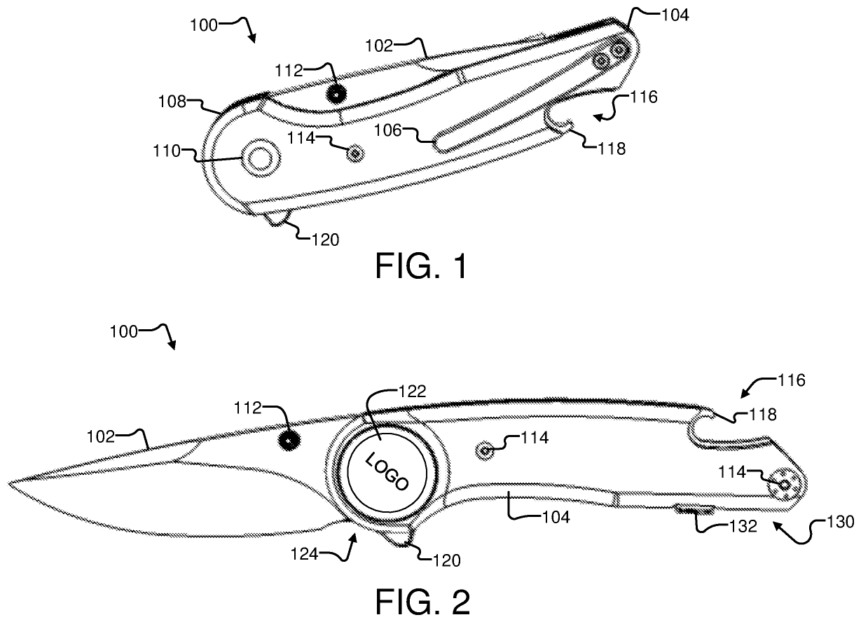

According to various aspects of the invention, the present devices and apparatuses can comprise multiple configurations. For example, exemplary embodiments of the inventive golf devices and apparatuses are shown in FIGS. 1-17.

In further aspects, the device may comprise a housing configured to house one or more tool elements and/or components. In still further aspects, the housing may be configured to contains at least one cutting element and at least one divot tool element. In some aspects, a housing or at least one surface of a housing, may be shaped or curved for easy gripping. The housing may be manufactured of a rigid material such as for illustrative purposes a plastic, metal, or wood, or a combination thereof. In some aspects, the housing may be comprised of a plurality of materials. For example, a first portion of a housing wall can be made of a different material than the remaining portion of the housing wall. In still further aspects, the housing may comprise one more housing plates disposed on an outer surface the housing which, in some aspects, may be made of a different material than the housing itself.

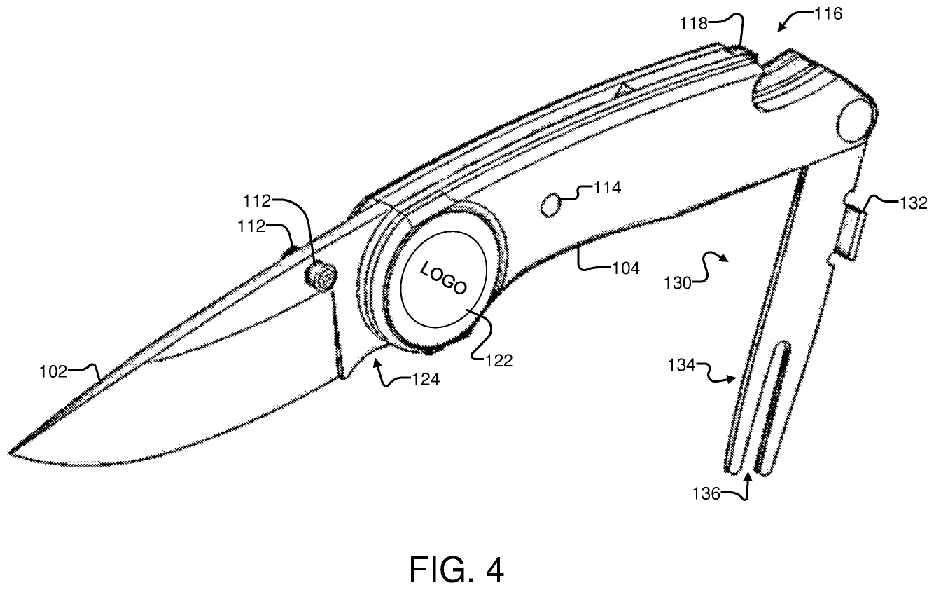

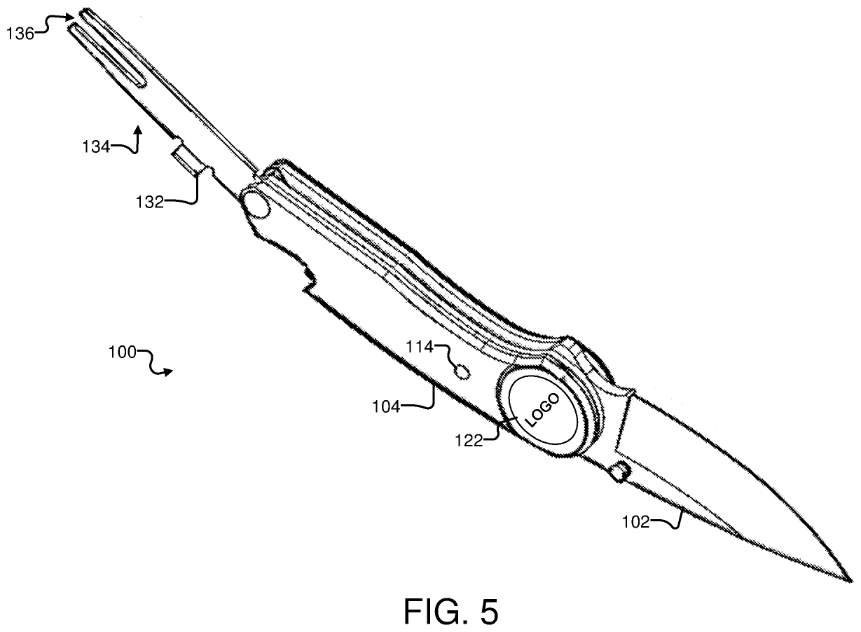

In further aspects, the housing can be any shape, and may be in the shape of a three-dimensional polygon and the housing walls may define an interior space or interior sections for containing the operating tool elements of the invention. Any other shape (as used herein, the term shape is used in the broad sense of three-dimensional works) may be employed, so long as the shape is large enough and structured so as to be able to contain the various working components of the invention and operate as disclosed herein. In some aspects, the housing may comprise a container with walls to define an enclosed area. In other aspects, as shown in FIGS. 4-5 the housing can comprise a plurality of plates connected by a plurality of members. In further aspects, the connected plates can define an interior space configured to contain the plurality of tool elements. In yet further aspects, the plates can be arranged in such an order that a first plate and second plate comprise the outer surfaces of the housing. In even further aspects, the device can comprise at least one additional plate disposed between first and second outer plates; wherein the at least one additional plate is configured to create a plurality of compartments within the housing. In further aspects, the housing may comprise members configured to maintain a space within the housing.

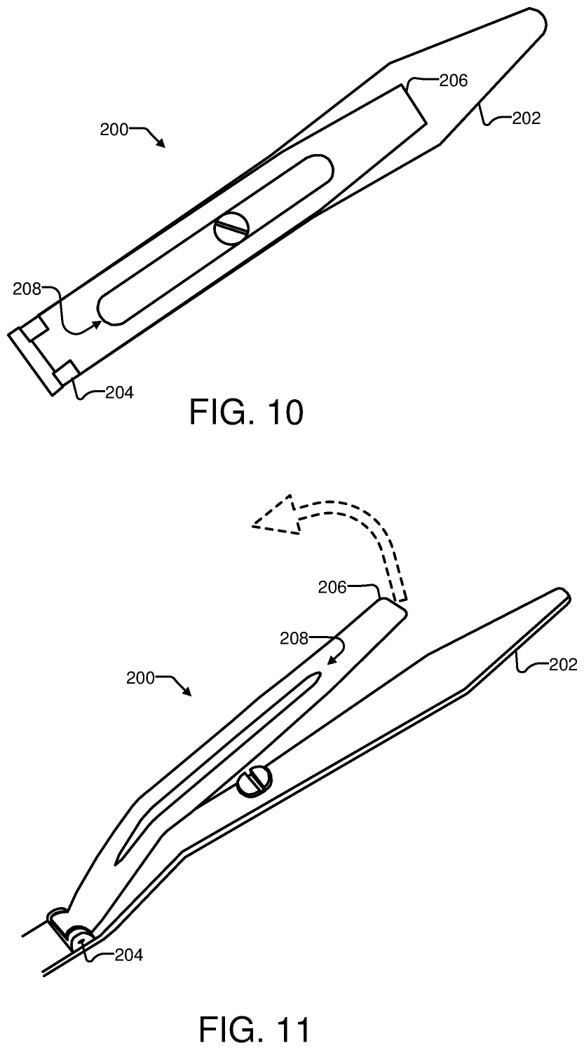

In further aspects, the device may comprise an attachment element connected or attached to the outer surface of the housing, such as shown in FIGS. 1, 7, 10, and 11. In yet further aspects, the attachment element can take the form of or otherwise comprise, for example, a clasp, clip or the like. As shown in FIGS. 10-11 the attachment element can further comprise a labeling guide connected to a portion of the attachment element. The labeling guide can be used as a stencil to draw a line on a golf ball. In still further aspects, the labeling guide can be pivotably connected to the attachment element at a hinge, as shown in FIGS. 10-11. When not in use, the labeling guide can be releasably secured to a portion of the attachment element using a securing means, such that the labeling guide is not movable and/or is substantially flush against the body of the attachment element.

In further aspects, the labeling guide may contain an aperture, the aperture being configured to be used as a stencil to draw a line on a golf ball. In still further aspects, the aperture of labeling guide can be further configured to be used to secure the labeling guide to a securing means of the attachment element, such as shown in FIG. 11. To this end, the labeling guide can remain secured to the attachment element so long the securing means is disposed within the aperture, and can be unsecured by pulling the labeling guide away from the attachment element.

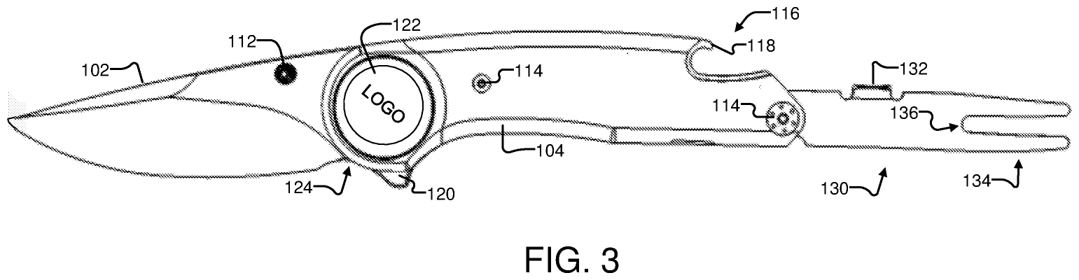

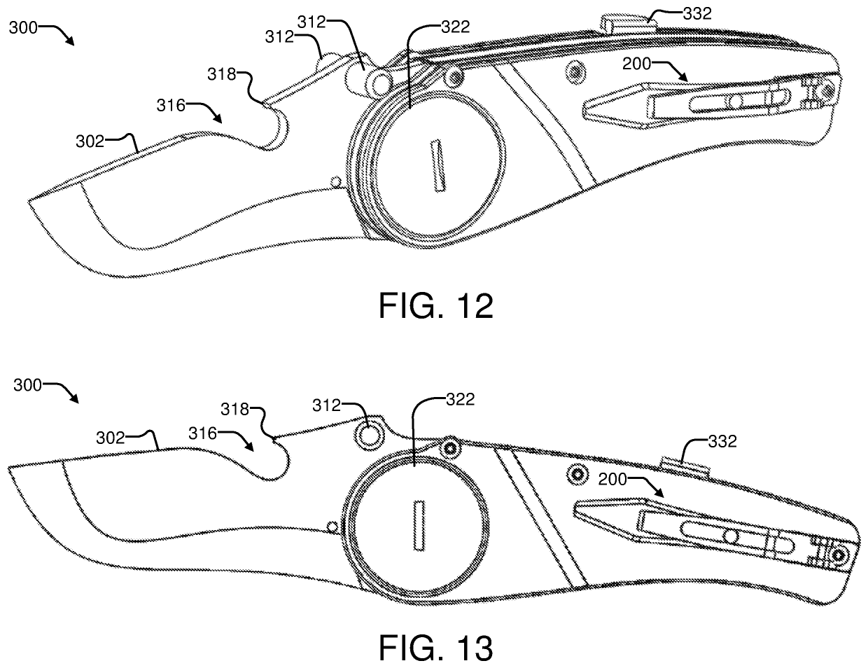

In various aspects, the plurality of tool elements may be connected or attached at a plurality of attachment points. For example, a first tool element may be connected to the device at a first attachment point, and a second tool element may be connected to the device at a second attachment point. As shown in FIGS. 3 and 12 the cutting element may be rotatably connected to the housing at a first attachment point, and the divot tool may be rotatably connected to the housing at a second attachment point. In further aspects, additional tool elements may be rotatably connect to each or both attachment points, such that the device can comprise a plurality of tool elements at one or both attachment points. In still further aspects, the plurality of tool elements may be contained in the same or different compartments within the housing. In some aspects, the divot tool and cutting element may be contained in different compartments within the housing. In other aspects, the divot tool and cutting element may be contained within same compartment within the housing.

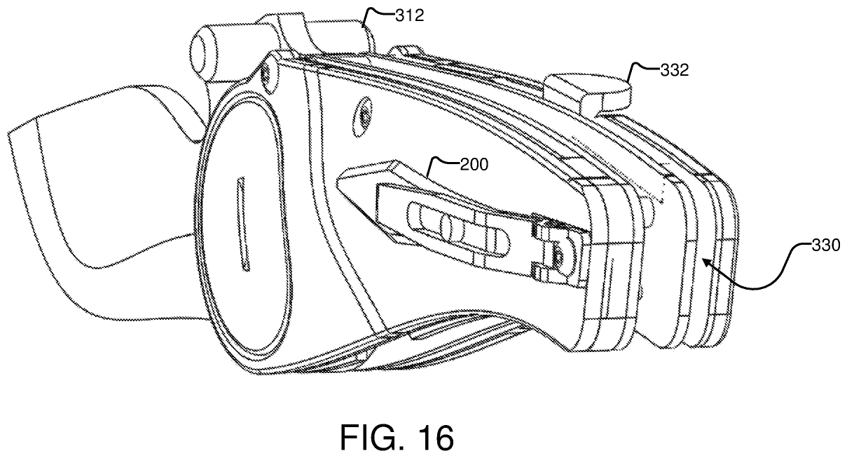

In various aspects, the tool elements may comprise one or more protrusions that assist with operation of the tool element. For example, as shown in FIGS. 4 and 16, protrusions connected to the tool element may be used by a user to move the tool element. The protrusion may also be configured to limit the travel and/or range of motion of the tool element, for example, when the element is moving from the open configuration to closed configurations, the protrusions prevent any further travel once in contact with a corresponding portion of the housing. In further aspects, a member, such as a housing member disposed within the housing, may alternatively or additionally act to limit travel of a tool element, for example, when the tool element comes in contact with said member.

In further aspects, each of the tool elements may comprise a locked state and/or unlocked state. In some aspects, the cutting element may comprise a locked state, wherein a locking mechanism is engaged and the cutting element position is fixed, and/or an unlocked state where the cutting element position can be moved. In other aspects, the divot tool may comprise a locked state, wherein a locking mechanism is engaged and the divot tool position is fixed, and/or an unlocked state where the divot tool position can be moved. As shown in FIGS. 1, 2, and 3, the plurality of tool elements may be movable between a closed configuration and an open configuration. In some aspects, the fully open position may correspond to a locked state. In other aspects, a closed position may correspond to a locked state. In further aspects, the locked state may require the user to disengage the locking mechanism to allow moving the tool element position.

In further aspects, the cutting element can comprise a cutting edge and a non-cutting edge. In still further aspects, the cutting element can comprise a bottle opening portion. In even further aspects, the bottle opening portion may be located along the non-cutting edge. In still further aspects, the cutting element may comprise a plurality of cutting edges. In yet further aspects, the cutting element may comprise a plurality of non-cutting edges.

In further aspects, the divot tool and the cutting element may be independently configurable. For example, the cutting element may be configured to be in an open configuration while the divot tool may be configured to be in an open position at the same time. In still further aspects, the cutting element may be configured to be in the closed configuration while the divot tool may be in the open configuration.

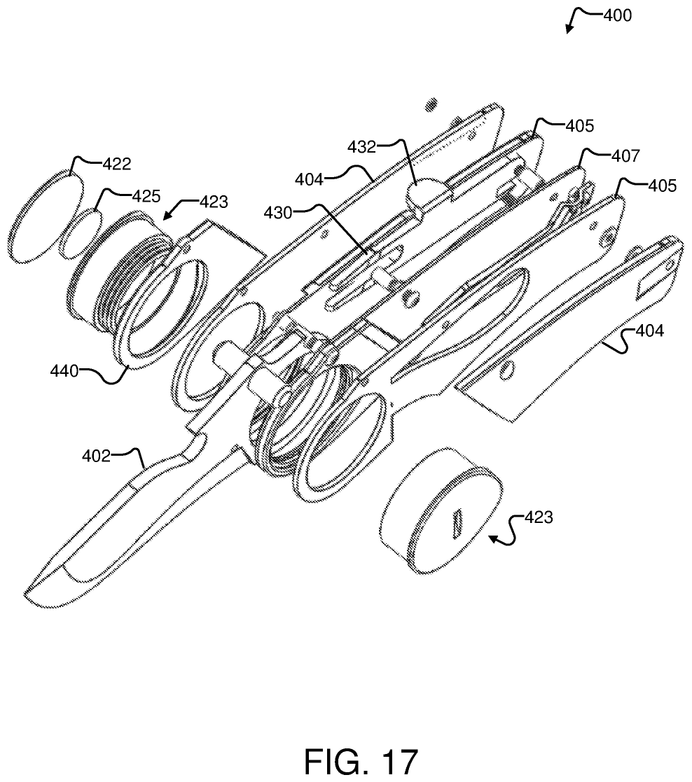

In further aspects, the device may comprise one or more ball markers. In still further aspects, an attachment point or a corresponding portion of the housing may comprise a cavity or void configured to retain a ball marker. As shown in FIGS. 4 and 17, a ball marker can be detachably secured to outer surface of the housing, for example, to a portion of the housing corresponding to a first attachment point associated with the cutting element. In yet further aspects, the ball marker may be magnetically connected to the housing and/or attachment point using a magnetic source. In still further aspects, the ball marker may be configured to fit within a cavity on the device housing such that it is substantially flush with the surrounding surfaces, as shown in FIG. 4.

In various aspects, the components of the disclosed devices can be detachably attached. In further aspects, the components can be connected by a connecting means and/or fastening means. In still further aspects, the connecting means and/or fastening means can comprise a fitting, insert, adhesive, brazing, soldering, welding, spot weld, screw with nut, rivet, threading, friction fit, snap-fit, twist-lock, or interlocking mechanism or a combination thereof. In yet further aspects, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the device can comprise an engagement means for coupling and holding components together. In a further aspect, the engagement means can be a screwing mechanism, a click-lock mechanism, or friction mechanism, or the like. In further aspects, the device components can be integrally or mechanically attached to other components. In a yet further aspect, the disclosed components can be connected, attached, or mounted using a connecting means, the connecting means comprising a fitting, insert, adhesive, brazing, soldering, welding, spot weld, screw with nut, rivet, fitting, insert, threading, friction fit, or snap-fit or a combination thereof.

Turning now to the figures, a more detailed description of exemplary embodiments is presented. FIG. 1 shows a side view of a golf device or multi-tool 100 in a closed configuration, in accordance with an exemplary embodiment of the present invention. As shown, the multi-tool includes a cutting element 102 arranged to pivot about an axis from pivot portion 110. The multi-tool 100 may further include a thumb portion 112 (e.g., a cut edge, hinge pin, or other assistive element) on the cutting element configured to allow easy opening. The cutting element 102 also includes a functional fin protrusion 120 allowing relative ease of opening the tool.

The multi-tool 100 also includes a body portion 104. The body portion 104 may be formed of plastic, fiberglass, or phenolic resin, sandwiched about metal components such as stainless steel or titanium. The body also includes a curved portion 108 about the pivot 110. The curved portion is easy to slip into a pocket or golf accessory bag while avoiding snags, tears, or injury.

The multi-tool 100 can also include an attachment clip 106 or securing component. The securing component 106 allows a user to comfortably wear the device 100 without fear of damage to pants or pockets.

The multi-tool also includes a hawk-bill bottle prying tool 116 with hawk-bill tip 118, arranged to engage with a bottle cap and easily pry it off. According to one aspect, the prying tool is formed of the same or similar metals as the cutting element 102.

FIG. 2 shows a side view of golf device or multi-tool 100 in a knife open configuration, in accordance with an exemplary embodiment of the present invention. In this configuration, the cutting element 102 is fully open and locked. Furthermore, a curved portion 124 defined by fin 120 allows a user to easily grip the multi-tool 100 with a reduced risk of slipping.

FIG. 3 shows a side view of a golf device in a fully open configuration, in accordance with an exemplary embodiment of the present invention. As shown in both FIG. 2 and FIG. 3, divot tool 130 is arranged within the housing 104 with resting/opening assist tab 132. The divot tool also includes a bifurcated tip portion 134 having a slot or aperture 136 arranged therethrough. This slot 136 allows a user to quickly mark a straight line for putting.

As shown in FIG. 3, a magnetic ball maker (with included indicia or a printed logo) is attached through or to the body 104. Furthermore, attachment components 114 allow the multi-tool to remain safely intact during use.

FIG. 4 shows a perspective view of the golf device or multi-tool 100 in a partially open configuration, in accordance with an exemplary embodiment of the present invention. In this configuration, the cutting element 102 is fully locked, while the divot tool 130 remains partially open. This is particularly useful on a morning where grass is wet, as a user can insert the divot tool into the ground and rest club handle upon the multi-tool or the bottle engaging portion 116 to avoid fouling their grips.

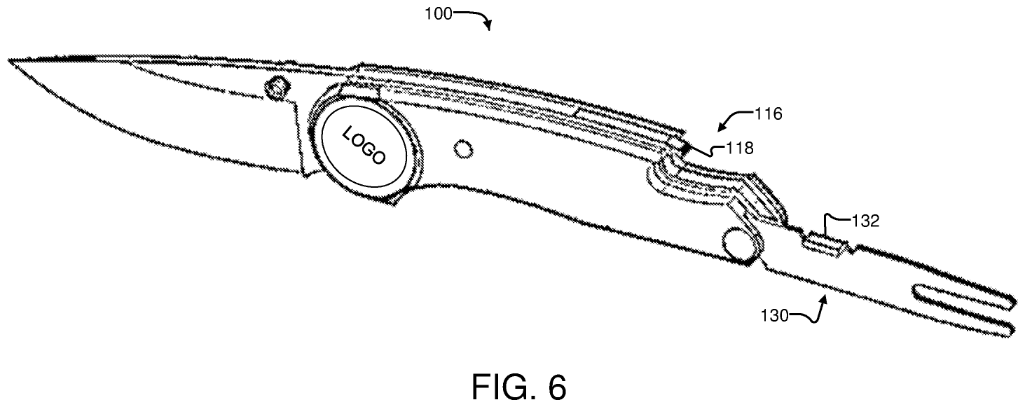

FIG. 5 shows a perspective view of the golf device or multi-tool 100 in a fully open configuration, in accordance with an exemplary embodiment of the present invention. FIG. 6 shows a perspective view of the golf device or multi-device 100 in a fully open configuration, in accordance with an exemplary embodiment of the present invention. As shown in FIGS. 5-6, the multi-tool includes a cavity defined by least two sides of the body portion 104.

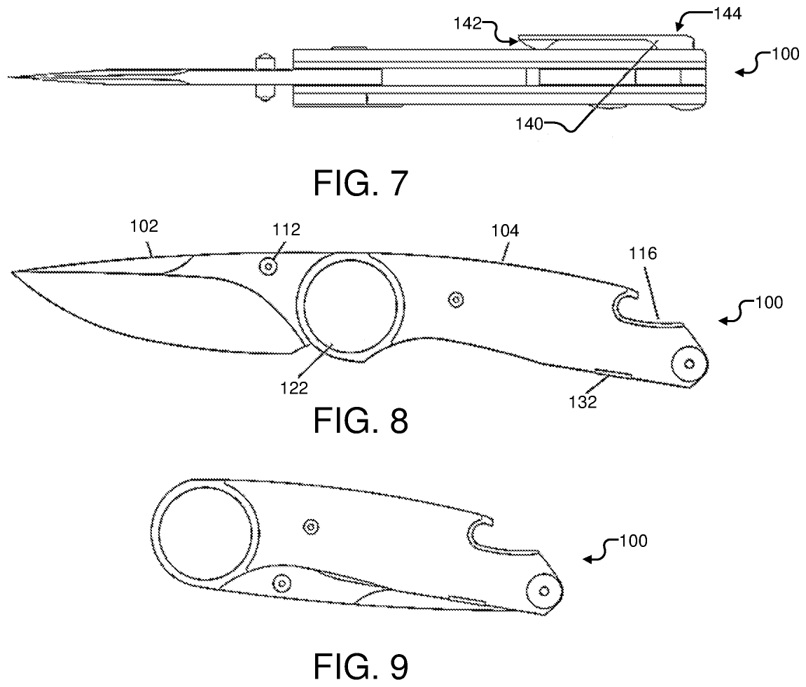

FIG. 7 shows a top view of the golf device or multi-tool 100 in a knife open configuration, in accordance with an exemplary embodiment of the present invention. FIG. 8 shows a side view of the golf device or multi-tool 100 in a knife open configuration, in accordance with an exemplary embodiment of the present invention. FIG. 9 shows a side view of the golf device or multi-tool 100 in a closed configuration, in accordance with an exemplary embodiment of the present invention. As readily apparent in FIG. 7-9, the pivot 112 is arranged on two sides, and the attachment device 140 includes an attachment portion 144 to attach to the body 104 and a retention protrusion 142 to aid in securing the multi-tool 100 to one's person.

FIG. 10 shows a top view of an attachment assembly 200 of a golf device, in accordance with an exemplary embodiment of the present invention. FIG. 11 shows a perspective view of the attachment assembly 200 of the golf device, in accordance with an exemplary embodiment of the present invention. The attachment assembly 200 may include a base portion or clip 202 and a hinge 204 for pivotally attaching a line stencil 206. Line stencils are used to mark golf balls with a straight line to aid in preparing to put. The line stencil 206 may be pivoted away as denoted by the dashed arrow, and quickly and easily mark a straight line on a golf ball.

FIG. 12 shows a perspective view of an alternative golf device 300 in a knife open configuration, in accordance with an exemplary embodiment of the present invention. FIG. 13 shows a side view of the alternative golf device 300 in a knife open configuration, in accordance with an exemplary embodiment of the present invention. As shown the multi-tool includes a cutting element 302 arranged to pivot about an axis from pivot portion arranged behind magnetic ball marker 322. The multi-tool 300 may further include a thumb portion 312 (e.g., a cut edge, hinge pin, or other assistive element) on the cutting element configured to allow easy opening. The cutting element 302 also includes a functional bottle cap opener 316 attached to or formed from the same material as the cutting element 302. The hawk bill tip 318 may also be used to aid in opening or pivoting the cutting element 302, allowing relative ease of opening the tool.

The multi-tool 300 can also include an attachment clip 200 or securing component. The securing component also a user to comfortably wear the device without fear of damage to pants or pockets.

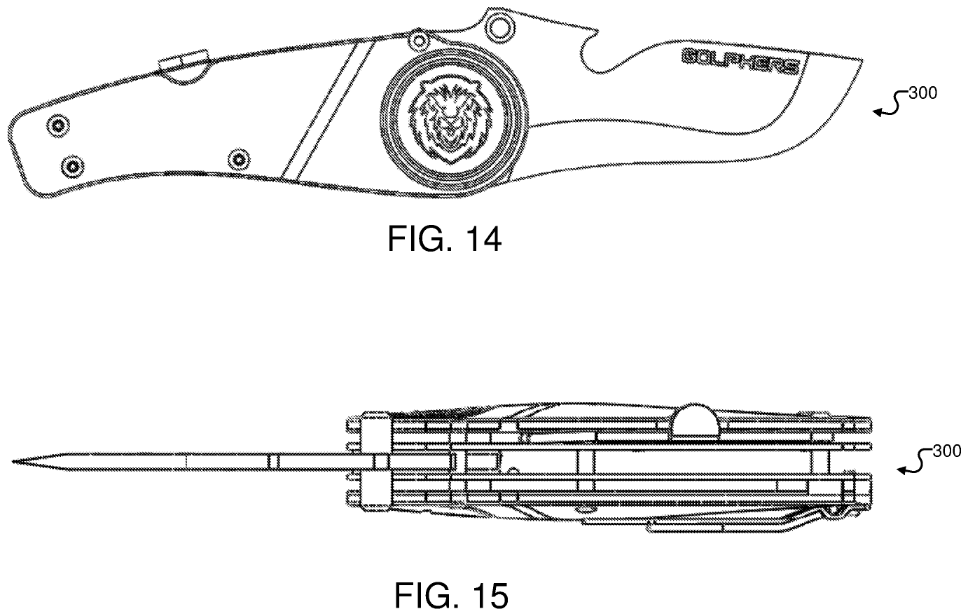

FIG. 14 shows a side view of the alternative golf device 300 in a knife open configuration, in accordance with an exemplary embodiment of the present invention. FIG. 15 shows a top view of the alternative golf device 300 in a knife open configuration, in accordance with an exemplary embodiment of the present invention.

FIG. 16 shows a rear perspective view of the alternative golf device 300 in a knife open configuration, in accordance with an exemplary embodiment of the present invention. Additionally, the multi-tool 300 includes a divot tool 330 having an assist tab 332 arranged thereon.

FIG. 17 shows an exploded assembly view of a golf device 400, in accordance with an exemplary embodiment of the present invention. As is shown, magnetic golf markers 422 and magnetic securing element 425 is arranged on end cap 423.

As further shown, the multi-tool device 400 body panels 404 are arranged about multiple tools 432 and 402. There are also centrally rigid members 405, 407 arranged to be within the body panels 404.

### C. Methods for Using the Golf Devices

The present disclosure, according to further aspects, also provides methods of using the disclosed devices.

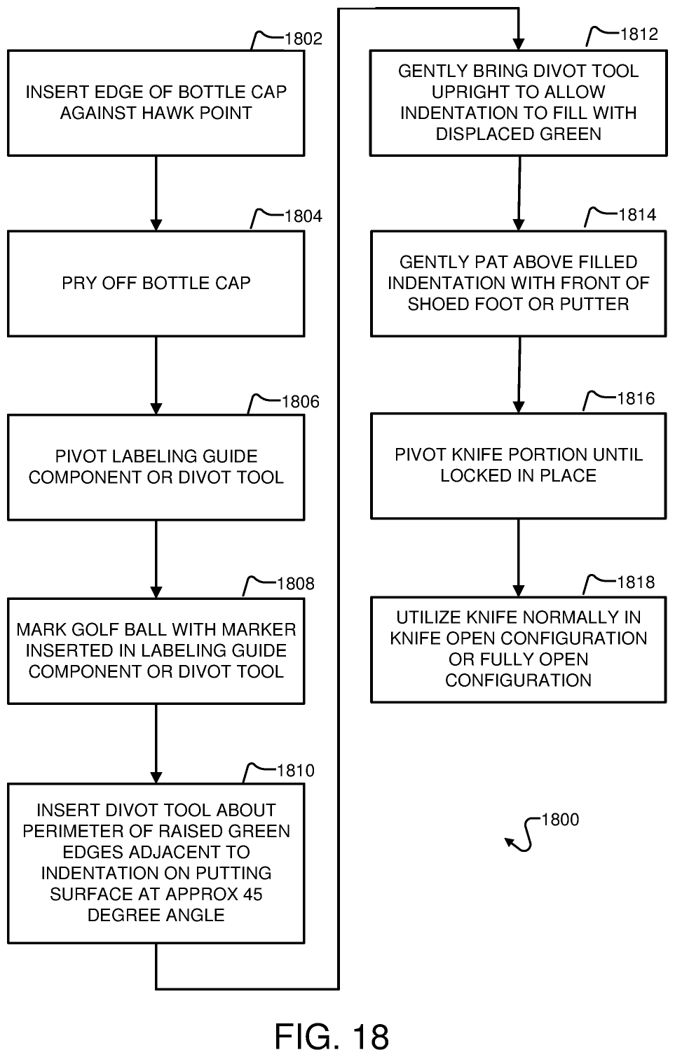

FIG. 18 is a flowchart of a method of using a golf device, including the golf devices illustrated in FIGS. 1-17, in accordance with an exemplary embodiment of the present invention.

For example, in one aspect, disclosed herein is a method for marking a ball using the disclosed device. In another aspect, disclosed herein is a method for retaining the location of a ball using a magnetic ball marker of the device. In yet another aspect, disclosed herein is a method for fixing divots in the ground using a divot tool element of a disclosed device.

In further aspects, the a disclosed method may further comprises the step(s) of using a tool element by moving the tool element (e.g., cutting element or divot tool) to its open position from a closed position, which can comprise using protrusions connected to the tool element to move the tool element in a radial direction away from the housing, rotating about an axis corresponding to its attachment point until open, which can require engaging a locking mechanism. To move the tool element to a closed position from an open position, the tool element can be moved in the opposite radial direction towards the housing. In yet further aspects, the method may further comprise the step(s) of using the labeling guide of the attachment element by unsecuring the labeling guide from the attachment element, pivotably moving the labeling guide and using the aperture as a stencil for drawing a line on a ball, and resecuring the labeling guide to the attachment element using the aperture.

For example, as illustrated in FIG. 18, the method 1800 can include engaging an edge of a bottle cap and prying off the bottle cap (1802, 1804). The method 1800 can also include pivoting a labeling guide component or a divot tool to mark a golf ball with a marker (e.g., a felt pen or permanent marker) inserted in a labeling guide component or the divot tool (1806, 1808).

The method 1800 can also include inserting the divot tool about the perimeter of raised green edges adjacent to an indentation on a putting surface at approximately a 45-degree angle (1810). The method 1800 further includes gently bringing the divot tool upright to allow the indentation to fill with displaced green from the motion of the tool. The method 1800 also includes gently patting about the filled indentation with the front of a shoed foot or bottom of a putter (1814). This ensures the green recovers nicely within a reduced amount of time.

The method also includes pivoting a knife or cutting portion until it is locked in a knife open configuration (1816); and utilizing the knife or cutting portion in knife open configuration or fully open configuration (1818).

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### D: Aspects

As stated above, a plurality of aspects may be used to describe features of the invention. The plurality of aspects can include:

Aspect 1: A multiple purpose device comprising: a plurality of tool elements contained within a housing, the tool elements comprising at least one cutting element and one divot tool element; a plurality of locking mechanisms, each locking mechanism in operable communication with a tool element and configured to retain the tool element within the housing in a locked state; an attachment element connected to the outer surface of the housing; and a ball marker releasably secured to a portion of the housing.

Aspect 2: The device any preceding aspect, wherein the housing comprises a plurality of plates connected by a plurality of members, wherein connected plates define an interior space configured to contain the plurality of tool elements.

Aspect 3: The device any preceding aspect, further comprising at least one additional plate disposed between first and second outer plates; wherein the at least one additional plate is configured to create a plurality of compartments.

Aspect 4: The device any preceding aspect, wherein the attachment element comprises a labeling guide pivotably connected to the attachment element.

Aspect 5: The device any preceding aspect, wherein the attachment element further comprises a securing means for releasably securing the labeling guide to the attachment element such that the labeling guide element does not pivot.

Aspect 6: The device any preceding aspect, wherein the labeling guide is connected to the attachment element using a hinge.

Aspect 7: The device any preceding aspect, wherein the labeling guide is configured to detach from the securing means.

Aspect 8: The device any preceding aspect, wherein the labeling guide comprises an aperture, the aperture being configured to be used to outline or stencil a line on a ball.

Aspect 9: The device any preceding aspect, wherein the aperture is configured to secure to the attachment means by connecting a portion of the attachment element within the aperture.

Aspect 10: The device any preceding aspect, wherein the attachment element is rotatable about a hinge arranged on the attachment means.

Aspect 11: The device any preceding aspect, wherein the ball marker is releasably secured to the housing using a magnetic source.

Aspect 12: The device any preceding aspect, wherein the attachment element comprises a clasp or clip.

Aspect 13: The device any preceding aspect, wherein the cutting element is rotatably connected to the housing at a first attachment point, and the divot tool is rotatably connected to the housing at a second attachment point.

Aspect 14: The device any preceding aspect, wherein the cutting element and the divot tool are each movable between a closed configuration and an open configuration.

Aspect 15: The device any preceding aspect, wherein the cutting element comprises a cutting edge and a non-cutting edge.

Aspect 16: The device any preceding aspect, further comprising a plurality of protrusions of predetermined sizes connected to one or more of the plurality of tool elements.

Aspect 17: The device any preceding aspect, wherein the protrusions are configured to assist in moving the tool elements from a closed configuration to an open configuration, and vice versa.

Aspect 18: The device any preceding aspect, wherein the divot tool is rotatably connected at a second attachment point.

Aspect 19: The device any preceding aspect, wherein the divot tool and the cutting element are independently configurable.

Aspect 20: The device any preceding aspect, wherein the divot tool is arranged as a bifurcated tool with an aperture arranged to make straight lines on golf balls.

Aspect 21: The device of any proceeding aspect, wherein the cutting element and divot tool element are configured to allow both to be in an open position at the same time.

Aspect 22: The device of any proceeding aspect, wherein the cutting element comprises a locked state wherein the locking mechanism is engaged and the element position is fixed.

Aspect 23: The device of any proceeding aspect, wherein cutting element comprises an unlocked state where the cutting element position can be moved.

Aspect 24: The device of any proceeding aspect, wherein the divot tool comprises a locked state wherein the locking mechanism is engaged and the divot tool position is fixed.

Aspect 25: The device of any proceeding aspect, wherein divot tool comprises an unlocked state where the divot tool position can be moved.

Aspect 26: The device of any proceeding aspect, wherein the divot tool and cutting element are in different compartments within the housing.

Aspect 27: The device of any proceeding aspect, wherein the divot tool and cutting element are in the same compartment within the housing.

Aspect 28: The device of any proceeding aspect, wherein the cutting element comprises a bottle opening portion.

Aspect 29: The device of any proceeding aspect, wherein the bottle opening portion is located along the non-cutting edge.

Aspect 30: The device of any preceding aspect, wherein the protrusions connected to a tool element can be configured to cutting element prevent the range of motion of the tool element, for example, when the tool element is moving from the open position to closed position, the protrusions may halt any further motion once to occur in the current direction.

Aspect 31: The device of any preceding aspect, wherein the ball marker, when disposed on the device housing is substantially flush with the surrounding device surfaces.

Aspect 32: The device of any preceding aspect, wherein the cutting element comprises a plurality of cutting edges.

Aspect 33: The device of any preceding aspect, wherein the cutting element comprises a plurality of non-cutting edges.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multiple purpose device comprising:
a plurality of tool elements contained within a housing, the tool elements comprising at least one cutting element and one divot tool element;
a plurality of locking mechanisms, each locking mechanism in operable communication with a tool element and configured to retain the tool element within the housing in a locked state;
an attachment element connected to the outer surface of the housing; and
a golf ball marker releasably secured to a portion of the housing.

2. The device of claim 1, wherein the housing comprises a plurality of plates connected by a plurality of members, wherein connected plates define an interior space configured to contain the plurality of tool elements.

3. The device of claim 2, further comprising at least one additional plate disposed between first and second outer plates; wherein the at least one additional plate is configured to create a plurality of compartments.

4. The device of claim 3, wherein the attachment element comprises a labeling guide pivotably connected to the attachment element.

5. The device of claim 4, wherein the attachment element further comprises a securing means for releasably securing the labeling guide to the attachment element such that the labeling guide element does not pivot.

6. The device of claim 3, wherein the labeling guide is connected to the attachment element using a hinge.

7. The device of claim 3, wherein the labeling guide is configured to detach from the securing means.

8. The device of claim 3, wherein the labeling guide comprises an aperture, the aperture being configured to be used to outline or stencil a line on a ball.

9. The device of claim 8, wherein the aperture is configured to secure to the attachment means by connecting a portion of the attachment element within the aperture.

10. The device of claim 9, wherein the attachment element is rotatable about a hinge arranged on the attachment means.

11. The device of claim 1, wherein the golf ball marker is releasably secured to the housing using a magnetic source.

12. The device of claim 1, wherein the attachment element comprises a clasp or clip.

13. The device of claim 1, wherein the cutting element is rotatably connected to the housing at a first attachment point, and the divot tool is rotatably connected to the housing at a second attachment point.

14. The device of claim 1, wherein the cutting element and the divot tool are each movable between a closed configuration and an open configuration.

15. The device of claim 1, wherein the cutting element comprises a cutting edge and a non-cutting edge.

16. The device of claim 1, further comprising a plurality of protrusions of predetermined sizes connected to one or more of the plurality of tool elements.

17. The device of claim 16, wherein the protrusions are configured to assist in moving the tool elements from a closed configuration to an open configuration, and vice versa.

18. The device of claim 1, wherein the divot tool is rotatably connected at a second attachment point.

19. The device of claim 1, wherein the divot tool and the cutting element are independently configurable.

20. The device of claim 1, wherein the divot tool is arranged as a bifurcated tool with an aperture arranged to make straight lines on golf balls.
